(19) United States
(12) Patent Application Publication
(10) Pub. No.: US 2015/0049274 A1
(43) Pub. Date: Feb. 19, 2015

(54) DISPLAY APPARATUS AND METHOD OF DRIVING THEREOF

(71) Applicant: Samsung Display Co., LTD., Yongin-City (KR)

(72) Inventors: Sang-Mi KIM, Yongin-si (KR); Kyoung-Won LEE, Seoul (KR); Ho-Yong JUNG, Seongnam-si (KR); Cheol-Woo PARK, Suwon-si (KR); Tae-Hyeong AN, Jeonju-si (KR); Hee-Soon JEONG, Suwon-si (KR)

(73) Assignee: Samsung Display Co., LTD., Yongin-City (KR)

(21) Appl. No.: 14/280,947

(22) Filed: May 19, 2014

(30) Foreign Application Priority Data
Aug. 16, 2013 (KR) 10-2013-0097247

(51) Int. Cl. G02F 1/133

(52) U.S. Cl. CPC G02F 1/13306
USPC 349/41

(57) ABSTRACT

A display apparatus includes: a display panel including a gate line, a data line, a switching element connected to the gate line and the data line, a liquid crystal capacitor having a first terminal connected to the switching element, and a storage capacitor having a first terminal connected to the switching element; and a leakage current generating part which generates a leakage current in the switching element.

This application claims priority to Korean Patent Application No. 10-2013-0097247, filed on Aug. 16, 2013, and all the benefits accruing therefrom under 35 U.S.C. §119, the content of which in its entirety is herein incorporated by reference.

### BACKGROUND

1. Field

Exemplary embodiments of the invention relate to a display apparatus and a method of driving the display apparatus. More particularly, exemplary embodiments of the invention relate to a display apparatus, in which image degradation that occurs when driven at a low frequency is substantially reduced, and a method of driving the display apparatus.

2. Description of the Related Art

Generally, a liquid crystal display displays images by controlling the light transmittance of liquid crystal cells in response to a video signal. A liquid crystal display of an active matrix type actively controls data by switching a data voltage applied to the liquid crystal cells using a thin film transistor (“TFT”) provided at every liquid crystal cell, thereby improving the picture quality of a motion image.

When a display panel is driven at a low frequency such as about 30 hertz (Hz) to display a still image, a power consumption of the display panel is reduced in comparison with a driving at a frequency of about 60 Hz. That is, a previous data is maintained without refreshing data, and then a driving frequency is selected by adjusting a refreshing time of a next data to reduce power consumption of the display panel.

When a voltage of a pixel is decreased at a low frequency, a luminance is decreased. When data are refreshed in a next frame, a luminance is suddenly increased such that a flicker may be recognized. For example, since a luminance variation amount is great at a low frequency, such as a frequency less than about 30 Hz, a flicker may be recognized.

The luminance may be decreased by a remaining direct current (“DC”) component that is generated when a pixel is not refreshed for a long time, or a leakage current of a TFT.

When the display panel is driven at a low frequency, the flicker characteristics may be substantially clearly recognized in an intermediate gradation, which is typically contained in a still image.

### SUMMARY

Exemplary embodiments of the invention provide a display apparatus with reduced image degradation generated at a low frequency and with increased displayable gradation range by compensating a luminance profile of an intermediate gradation.

Exemplary embodiments of the invention also provide a method of driving the above-mentioned display apparatus.

According to an exemplary embodiment of the invention, a display apparatus includes a display panel and a leakage current generating part. The display panel includes a gate line, a data line, a switching element connected to the gate line and the data line, a liquid crystal capacitor having a first terminal connected to the switching element and a storage capacitor having a first terminal connected to the switching element. The leakage current generating part generates a leakage current in the switching element.

In an exemplary embodiment, the leakage current generating part may include a data driving part which provides the data line with a data signal. The data driving part may output a high data signal higher than the data signal corresponding to a white gradation of positive polarity after the switching element is turned off from a turn on status. The data driving part may further output a low data signal lower than the data signal corresponding to a white gradation of negative polarity after the switching element is turned off from a turn on status.

In an exemplary embodiment, the leakage current generating part may include a data driving part providing the data line with a data signal. The data driving part may output an analog voltage higher than the data signal corresponding to a white gradation of positive polarity after a frame scanning is completed. The data driving part may output an analog voltage lower than the data signal corresponding to a white gradation of negative polarity after the frame scanning is completed.

In an exemplary embodiment, the leakage current generating part may include a gate driving part which provides the gate line with a gate signal. The gate driving part may selectively output a gate-off voltage to the gate line based on a percentage of a high gradation or a low gradation of a full still image.

In an exemplary embodiment, the gate driving part may output the gate-off voltage of about −5 volt (V) when a percentage of a white image or a black image of the full still image is equal to or greater than a predetermined percentage, and the gate driving part may output the gate-off voltage of about −0.4 V when a percentage of the white image or the black image of the full still image is less than the predetermined percentage.

In an exemplary embodiment, the leakage current generating part may include a reference voltage applying part which provides a second terminal of the storage capacitor with a storage voltage. The reference voltage applying part may output a voltage higher than a storage voltage applied to the storage capacitor after the switching element is turned off from the turn-on state.

In an exemplary embodiment, the display panel may be driven at a low frequency lower than about 60 hertz (Hz).

According to another exemplary embodiment of the invention, a method of driving a display apparatus, including a gate line, a data line, a switching element connected to the gate line and the data line, a liquid crystal capacitor having a first terminal connected to the switching element and a storage capacitor having a first terminal connected to the switching element, includes: providing the gate line with a turn-on voltage to turn on the switching element; providing the data line with a data signal to charge the liquid crystal capacitor and the storage capacitor; providing the gate line with a turn-off voltage to turn off the switching element; and providing the data line with a high data signal higher than the data signal corresponding to a white gradation of positive polarity to generate a leakage current in the switching element after the switching element is turned off from a turn-on state.

In an exemplary embodiment, the method may further include providing the data line with a low data signal lower than the data signal corresponding to a white gradation of negative polarity to generate the leakage current in the switching element after the switching element is turned off from the turn-on state.

According to another exemplary embodiment of the invention, a method of driving a display apparatus, including a gate line, a data line, a switching element connected to the gate line and the data line, a liquid crystal capacitor having a first terminal connected to the switching element and a storage capacitor having a first terminal connected to the switching element, includes: providing the gate line with a turn-on voltage to turn on the switching element; providing the data line with a data signal to charge the liquid crystal capacitor and the storage capacitor; providing the gate line with a turn-off voltage to turn off the switching element; and providing the data line with an analog voltage higher than the data signal corresponding to a white gradation of positive polarity to generate a leakage current in the switching element after a frame scan is completed.

In an exemplary embodiment, the method may further include providing the data line with an analog voltage lower than the data signal corresponding to a white gradation of negative polarity to generate the leakage current in the switching element after the frame scan is completed.

According to another exemplary embodiment of the invention, a method of driving a display apparatus, including a gate line, a data line, a switching element connected to the gate line and the data line, a liquid crystal capacitor having a first terminal connected to the switching element and a storage capacitor having a first terminal connected to the switching element, includes: providing the gate line with a turn-on voltage to turn on the switching element; providing the data line with a data signal to charge the liquid crystal capacitor and the storage capacitor; and selectively providing the gate line with a gate-off voltage based on a percentage of a high gradation or a low gradation of a full still image displayed on the display panel to generate a leakage current.

In an exemplary embodiment, the gate-off voltage of about −5 V may be provided to the gate line when a percentage of a white image or a black image of the full still image is equal to or greater than a predetermined percentage, and the gate-off voltage of about −0.4 V may be provided to the gate line when the percentage of the white image or the black image of the full still image is less than the predetermined percentage.

According to another exemplary embodiment of the invention, a method of driving a display apparatus, including a gate line, a data line, a switching element connected to the gate line and the data line, a liquid crystal capacitor having a first terminal connected to the switching element and a storage capacitor having a first terminal connected to the switching element, includes: providing the gate line with a turn-on voltage to turn on the switching element; providing the data line with a data signal to charge the liquid crystal capacitor and the storage capacitor; providing the gate line with a turn-off voltage to turn off the switching element; and providing a second terminal of the storage capacitor with a voltage higher than a storage voltage applied to the storage capacitor to generate a leakage current in the switching element, after the switching element is turned off from a turn-on state.

According to exemplary embodiments of a display apparatus and a method of driving the display apparatus, a leakage current is generated in a switching element, such that a luminance profile of an intermediate gradation is compensated to improve image degradation generated when the display apparatus is driven at a low frequency. In such embodiments, a displayable gradation range at a low frequency may be increased.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram schematically showing an exemplary embodiment of a display apparatus, according to the invention;

FIG. 2A is a circuit diagram of pixels of FIG. 1, showing charging/discharging characteristics of the pixels based on a gate-on voltage applied thereto;

FIG. 2B is a circuit diagram of pixels of FIG. 1, showing charging/discharging characteristics of the pixels based on a gate-off voltage applied thereto;

FIG. 2C is a circuit diagram of pixels of FIG. 1, showing charging/discharging characteristics of the pixels after one second from the application of the gate-off voltage;

FIG. 3 is a voltage-current (“V-I”) curve showing a drain-source current versus gate voltage of various switching elements;

FIG. 4 is a graph showing a luminance profile in accordance with a time before and after compensating a flicker using white leakage;

FIG. 5 is a block diagram schematically showing an alternative exemplary embodiment of a display apparatus, according to the invention;

FIG. 6 is a block diagram schematically showing an exemplary embodiment of a data driving part shown in FIG. 5;

FIG. 7 is a waveform diagram schematically showing an exemplary embodiment of an analog voltage shown in FIG. 5;

FIG. 8 is a circuit diagram of pixels of FIG. 5, showing charging/discharging characteristics of the pixels;

FIG. 9 is a block diagram schematically showing another alternative exemplary embodiment of a display apparatus, according to the invention;

FIG. 10 is a block diagram schematically showing an exemplary embodiment of a gate driving part shown in FIG. 9;

FIG. 11 is a signal timing diagram of gate signals outputted from an exemplary embodiment of the gate driving part of FIG. 10;

FIG. 12A is a graph showing a luminance profile in accordance with time before compensation;

FIG. 12B is a graph showing a luminance profile in accordance with time after compensation using white leakage;

FIG. 13 is a block diagram schematically showing another alternative exemplary embodiment of a display apparatus, according to the invention; and

FIG. 14 is a block diagram schematically showing an exemplary embodiment of a reference voltage applying part of FIG. 13.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of a display apparatus and a method of driving thereof, according to the invention, will be described in detail with reference to the accompanying drawings.

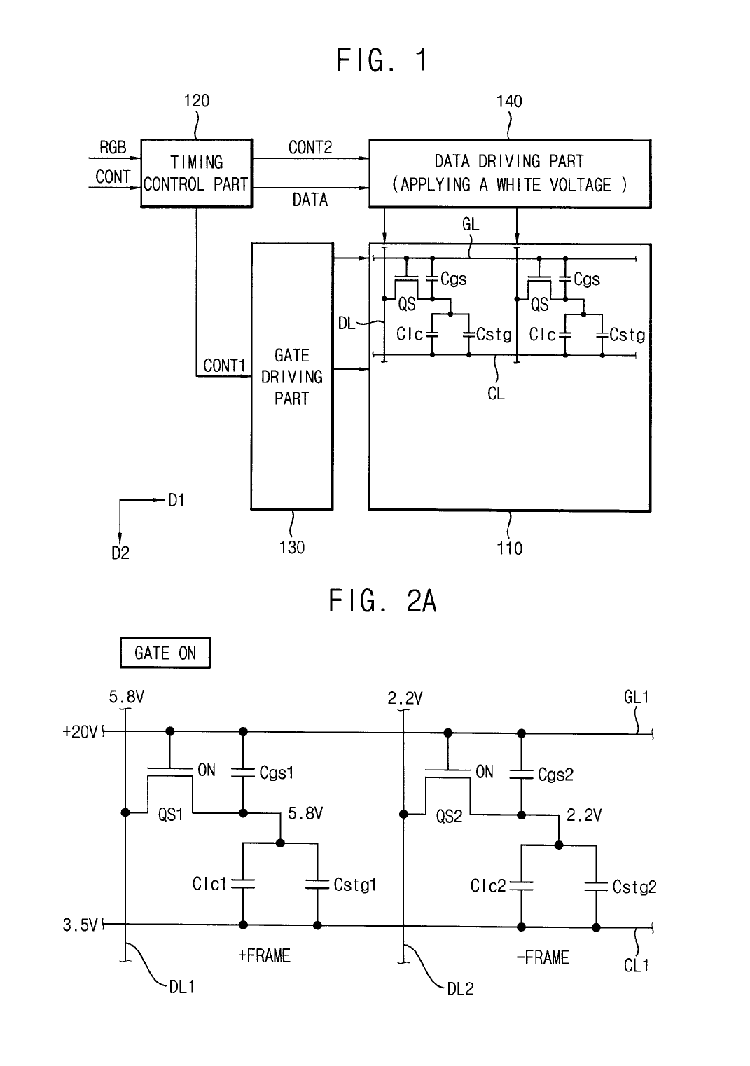

FIG. 1 is a block diagram schematically showing an exemplary embodiment of a display apparatus, according to the invention.

Referring to FIG. 1, an exemplary embodiment of a display apparatus includes a display panel 110, a timing control part 120, a gate driving part 130 and a data driving part 140. In an exemplary embodiment, the data driving part 140 may function as a leakage current generating part that generates a leakage current in a switching element disposed on the display panel 110 to improve image degradation due to flicker when the display panel 110 is driven at a low frequency.

The display panel 110 includes a plurality of gate lines GL, a plurality of data lines DL, a plurality of common electrode lines CL and a plurality of unit pixels electrically connected to the gate lines GL and the data lines DL. The gate lines GL extend substantially in a first direction D1, and the data lines DL extend substantially in a second direction D2. The first direction D1 may cross the second direction D2. The first direction D1 and the second direction D2 may be substantially perpendicular to each other.

Each of the unit pixels may include a switching element QS, a liquid crystal capacitor Clc electrically connected to the switching element QS and a storage capacitor Cstg electrically connected to the switching element QS. A first terminal of the liquid crystal capacitor Clc is connected to a drain electrode of the switching element QS, and a second terminal of the liquid crystal capacitor Clc is connected to a common electrode line CL. A first terminal of the storage capacitor Cstg is connected to the drain electrode of the switching element QS, and a second terminal of the storage capacitor Cstg is connected to the common electrode line CL. The unit pixels may be disposed substantially in a matrix form. In such an embodiment, a parasitic capacitor Cgs may be formed between the gate and drain electrodes of the switching element QS.

The timing control part 120 receives an input image data RGB and an input control signal CONT from an external device (not shown). The input image data may include a red image data, a green image data and a blue image data. The input control signal CONT may further include a clock signal, a data enable signal, a vertical start signal and a horizontal start signal.

The timing control part 120 generates a first driving control signal CONT1, a second control signal CONT2 and a data signal DATA in response to the input image data RGB and the input control signal CONT.

The timing control part 120 generates the first driving control signal CONT1 for controlling an operation of the gate driving part 130 in response to the input control signal CONT, and outputs the first driving control signal CONT1 to the gate driving part 140. The gate driving control signal CONT 1 may include a vertical start signal and a gate clock signal.

The timing control part 120 generates the second control signal CONT2 for controlling an operation of the data driving part 140 in response to the input control signal CONT, and outputs the second control signal CONT2 to the data driving part 140. The second control signal CONT2 may include a horizontal start signal and a load signal.

The gate driving part 130 generates gate signals for driving gate lines GL in response to the gate driving control signal CONT1 inputted from the timing control part 120. The gate driving part 130 sequentially outputs the gate signals to the gate lines GL. In one exemplary embodiment, for example, the gate driving part 130 may generate the gate signals outputted to the gate lines GL in response to the gate driving control signal CONT 1 including a first clock signal, a second clock signal having a phase different from the first clock signal and a vertical start signal. In such an embodiment, the second clock signal may be a signal inverted from the first clock signal.

In an exemplary embodiment, the gate driving part 130 may be directly mounted on the display panel 110 or connected to the display panel 110 in a tape carrier package (“TCP”) manner. Alternatively, the gate driving part 130 may be integrated on the display panel 110.

The data driving part 140 provides the data lines DL with a data signal. In one exemplary embodiment, for example, the data driving part 140 provides the data line with a data signal corresponding to a white gradation after the switching element QS is turned off after in a turn-on state.

In an exemplary embodiment, the data driving part 140 receives the second control signal CONT2 and the data signal DATA from the timing control part 120. The data driving part 140 converts the data signal DATA into a data voltage of analog type using a gamma reference voltage outputted from a gamma reference voltage generating part (not shown). The data driving part 140 outputs the data voltage to the data lines DL.

The data driving part 140 may include a shift register (not shown), a latch (not shown), a signal processing part (not shown) and a buffer part (not shown). The shift register outputs a latch pulse to the latch. The latch temporarily stores the data signal DATA, and then output the data signal DATA to the signal processing part. The signal processing part generates the data voltage of analog type based on the data signal DATA and the gamma reference voltage to output the data voltage to the buffer part. The buffer part compensates the data voltage to have a predetermined level, and then outputs the data voltage to the data lines DL.

In an exemplary embodiment of the display apparatus, the gate driving part 130 provides the gate lines GL with a turn-on voltage to turn on the switching element QS.

Then, the data driving part 140 provides the data line DL with a data signal to charge the liquid crystal capacitor Clc and the storage capacitor Cst, which are connected to the switching element QS.

Then, the gate driving part 130 provides a turn-off voltage with the gate line GL to turn off the switching element QS.

In an exemplary embodiment, after the switching element QS is turned off from a turn-on state, the data driving part 140 provides the data line DL with a high data signal higher than a data signal corresponding to a white gradation, which is applied to the data line DL.

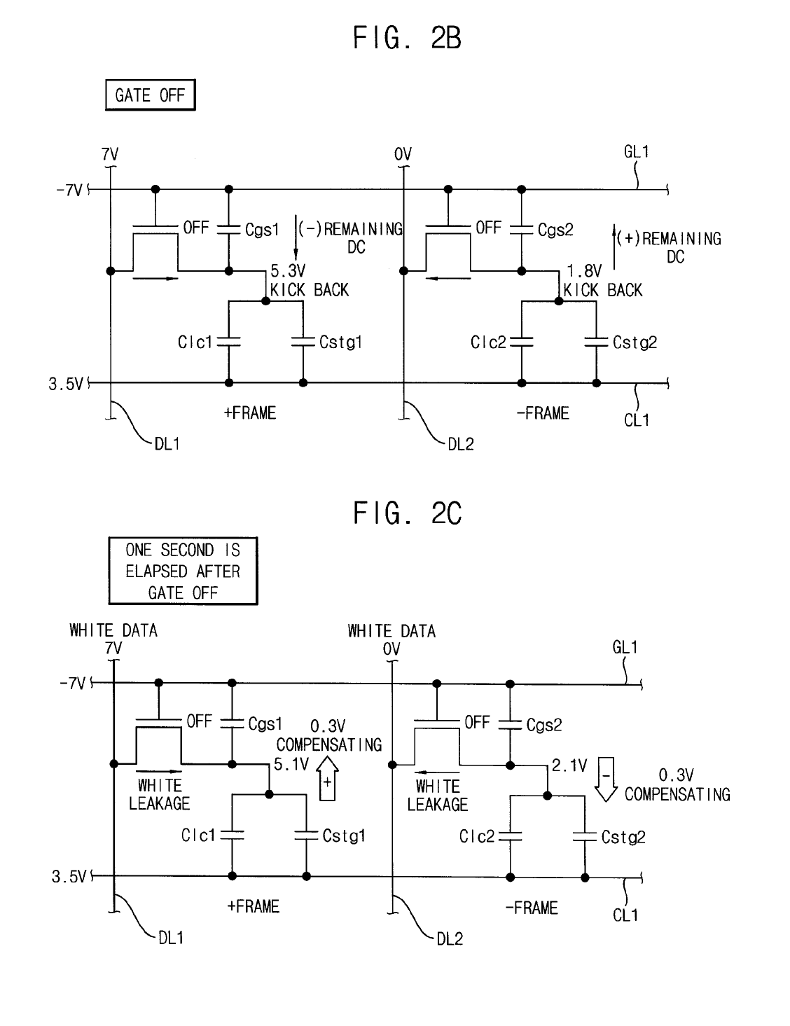

FIG. 2A is a circuit diagram of pixels of FIG. 1 showing charging/discharging characteristics of the pixels when a gate-on voltage is applied thereto. FIG. 2B is a circuit diagram of pixels of FIG. 1 showing charging/discharging characteristics of the pixels when a gate-off voltage is applied thereto. FIG. 2C is a circuit diagram of pixels of FIG. 1 showing charging/discharging characteristics of the pixels after one second from an application of the gate-off voltage.

Referring to FIG. 2A, when a gate-on voltage, such as about +20 volt (V), is applied to a first gate line GL1, a first switching element QS1 and a second switching element QS2, which are connected to the first gate line GL1, are turned on.

As the first switching element QS1 is turned on, a data signal of about 5.8 V applied through a first data line DL1 connected to the first switching element QS1 may be charged into a first liquid crystal capacitor Clc1 and a first storage capacitor Cstg1.

As a second switching element QS2 is turned on, a data signal of about 2.2 V applied through a second data line DL2 connected to a second switching element QS2 may be charged into a second liquid crystal capacitor Clc2 and a second storage capacitor Cstg2.

Referring to FIG. 2B, when a gate-off voltage, e.g., about −7 V, is applied to a first gate line GL1 after a gate-on voltage is applied to the first gate line GL1, a first switching element QS1 and a second switching element QS2 that are connected to the first gate line GL1 are turned off.

Even though a first switching element QS1 is turned off, a leakage current is flowing from a source electrode of the first switching element QS1 to a drain electrode of the first switching element QS1. Thus, a kickback current of about 5.3 V is generated in a parasitic capacitor Cgs1 between a gate electrode of the first switching element QS1 and a source electrode of the first switching element QS1, such that a remaining direct current (“DC”) component of negative polarity exists.

Generally, a kickback voltage is generated using a thin-film transistor including a gate electrode, a source electrode and a drain electrode. In detail, the drain electrode that overlaps a portion of the gate electrode forms a parasitic capacitor. Due to a parasitic capacitance of the parasitic capacitor defined between the gate electrode and the drain electrode, a data signal (or a data voltage) is shifted by a voltage, which is referred to as a kickback voltage. Remaining DC voltage is generated within a display panel due to the kickback voltage, and a remaining image is thereby displayed.

Even though a second switching element QS2 is turned off, a leakage current (white leakage) is flowing from a source electrode of the second switching element QS2 to a drain electrode of the second switching element QS2. Thus, a kickback current of about 1.8 V is generated in a parasitic capacitor Cgs2 between a gate electrode of the second switching element QS2 and a source electrode of the second switching element QS2, such that a remaining DC component of negative polarity exists.

Referring to FIG. 2C, in an exemplary embodiment, when about 1 second is elapsed after a gate-off voltage is applied to a first gate line GL1, a data signal of about 7 V (white data) is applied to a first data line DL1. Thus, a leakage current (white leakage) is continuously flowing from a source electrode of a first switching element QS1 to a drain electrode of the first switching element QS1, and a voltage of about 0.3 V is thereby compensated such that a voltage of the drain electrode of the first switching element QS1 is about 5.1 V.

When about 1 second is elapsed after the gate-off voltage is applied to the first gate line GL1, a data signal of about zero (0) V (white data) is applied to a second data line DL2. Thus, a leakage current is continuously flowing from a drain electrode of a second switching element QS2 to a source electrode of the second switching element QS2, and a voltage of about 0.3 V is thereby compensated such that a voltage of the drain electrode of the second switching element QS2 is about 2.1 V.

In an exemplary embodiment, as described above, a white data is applied to a pixel to compensate a luminance decreased due to a remaining DC component generated after the gate electrode is closed, such that a leakage current of a switching element is generated to increase a luminance.

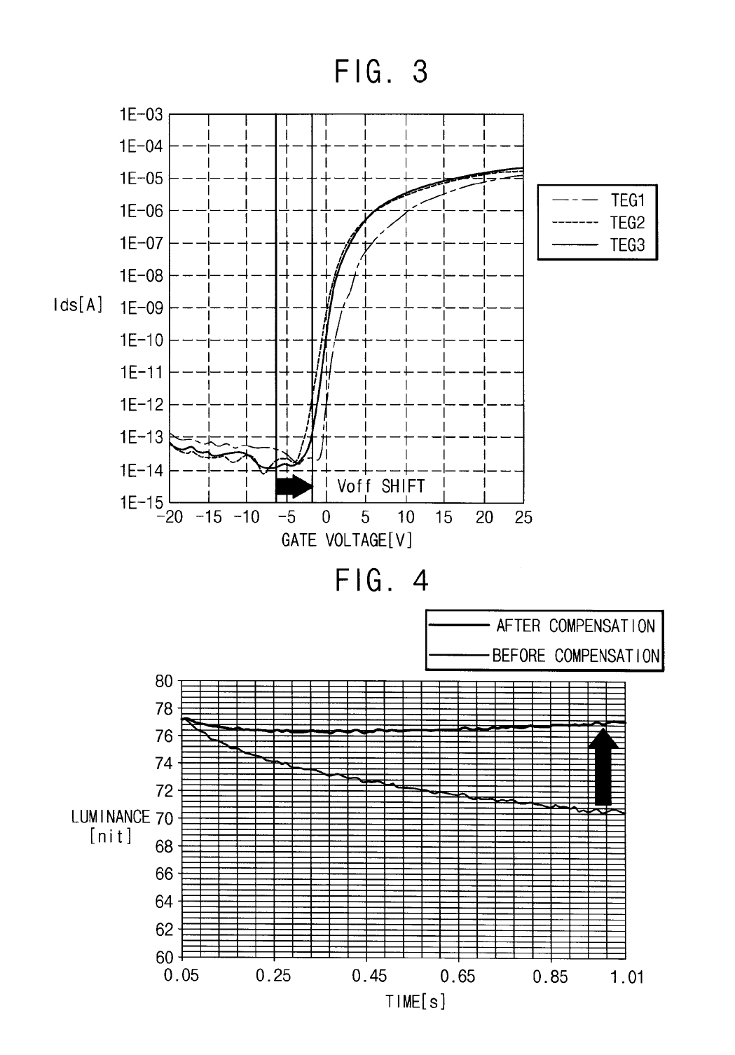

FIG. 3 is a voltage-current (“V-I”) curve schematically showing drain-source current (ampere: A) versus gate voltage (V) of various switching elements TEG1, TEG2 and TEG3.

Referring to FIG. 3, in an exemplary embodiment, the pixel includes a switching element, a gate-off voltage of which is shifted in a right side direction, that is, the gate-off voltage is increased, such that a sufficient leakage current when a white data is applied to a pixel to flow after a gate electrode is closed.

FIG. 4 is a graph explaining a luminance profile in accordance with a time before and after a flicker compensating using white leakage.

Referring to FIG. 4, when the white leakage is generated within a pixel, a luminance reduction is offset by compensating a voltage of the pixel decreasing in accordance with a time. For example, when a white data is not applied thereto, a luminance is gradually decreased from about 77 nits to about 70 nits after about 1.01 second (s).

In an exemplary embodiment, where a white data is applied thereto, a luminance is initially decreased, and the luminance is gradually increased after about 0.25 s. As shown in FIG. 4, the luminance is increased to be about 77 nits, which is substantially equal to an initial luminance, at about 1.01 s.

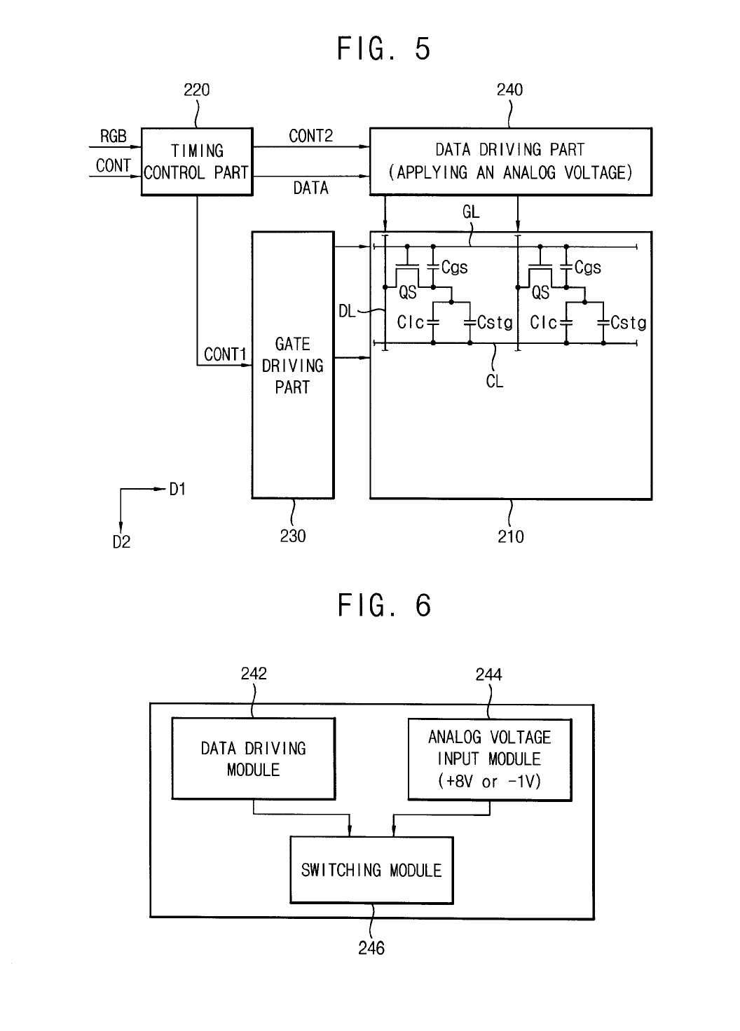

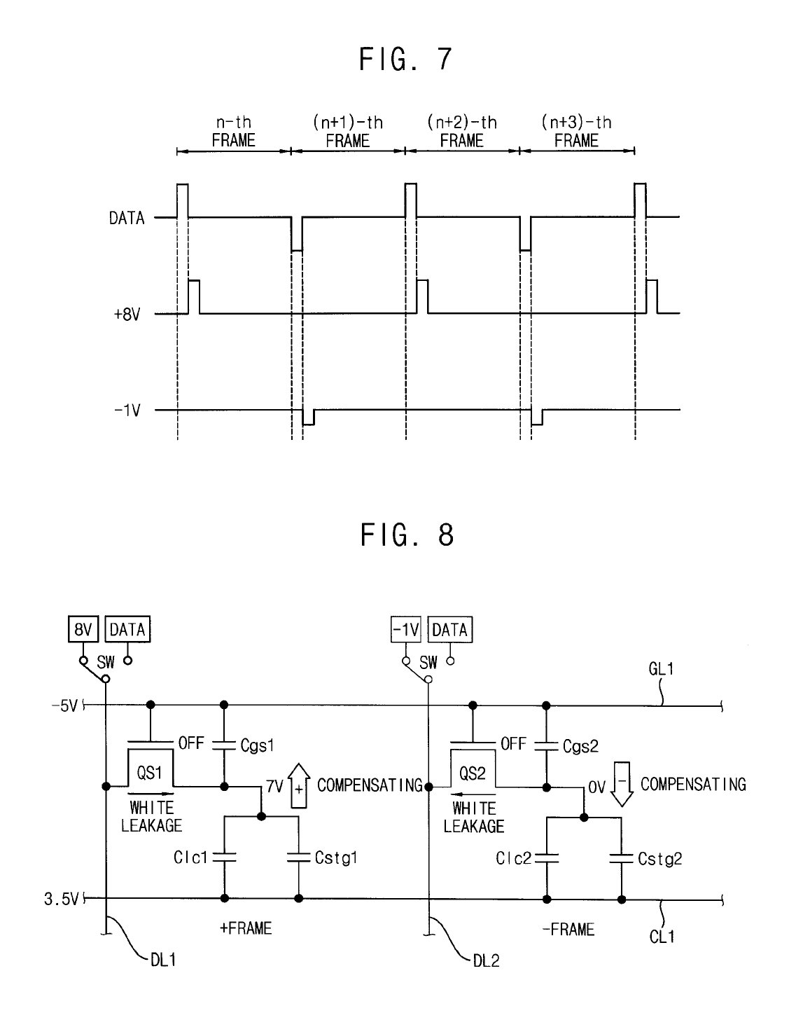

FIG. 5 is a block diagram schematically showing an alternative exemplary embodiment of a display apparatus, according to the invention. FIG. 6 is a block diagram schematically showing an exemplary embodiment of a data driving part shown in FIG. 5. FIG. 7 is a waveform diagram schematically showing an exemplary embodiment of an analog voltage shown in FIG. 5.

Referring to FIGS. 5 to 7, an alternative exemplary embodiment of a display device includes a display panel 210, a timing control part 220, a gate driving part 230 and a data driving part 240. In an exemplary embodiment, the data driving part 240 may function as a leakage current generating part that generates a leakage current in a switching element of the display panel 210 to improve image degradation due to flicker when the display panel 310 is driven at a low frequency.

The display panel 210, the timing control part 220 and the gate driving part 230 of the display device shown in FIG. 5 are substantially the same as the display panel 110, the timing control part 120 and the gate driving part 130 of the display device shown in FIG. 1, and thus any repetitive detailed description thereof may hereinafter be omitted or simplified.

In such an embodiment, as shown in FIG. 6, the data driving part 240 includes a data driving module 242, an analog voltage input module 244 and a switching module 246. The data driving part 240 provides the data line DL with a data signal, and provides the data line DL with an analog voltage after a frame scan is completed.

The data driving module 242 receives the second control signal CONT2 and the data signal DATA from the timing control part 220. The data driving part 240 converts the data signal DATA into a data voltage of analog type using a gamma reference voltage outputted from a gamma reference voltage generating part (not shown). The data driving part 240 outputs the data voltage to the switching module 246.

The data driving module 242 may include a shift register (not shown), a latch (not shown), a signal processing part (not shown) and a buffer part (not shown). The shift register outputs a latch pulse to the latch. The latch temporarily stores the data signal DATA and then output the data signal DATA to the signal processing part. The signal processing part generates the data voltage of analog type based on the data signal DATA and the gamma reference voltage to output the data voltage to the buffer part. The buffer part compensates the data voltage to have a predetermined level, and then outputs the data voltage to the data line DL.

The analog voltage input module 244 provides the switching module 246 with an analog voltage. The analog voltage has a vale greater than a data signal corresponding to a white gradation, which is applied to the data lines.

In one exemplary embodiment, for example, when a common electrode voltage is about 3.5 V, a data signal corresponding to a white gradation of positive polarity is about 7 V and a data signal corresponding to a white gradation of negative polarity is about zero (0) V. In such an embodiment, the analog voltage corresponding to the positive polarity may be about +8 V higher than about 7 V, and the analog voltage corresponding to the negative polarity may be about −1 V lower than about zero (0) V.

The switching module 246 outputs the data voltage of analog type outputted from the data driving module 242 or the analog voltage outputted from the analog voltage input module 244 to the data line DL. In an exemplary embodiment, an operation of the switching module 246 may be controlled by the timing control part 220. In one exemplary embodiment, for example, the timing control part 220 may start an operation of the switching module 246 after a frame scanning is completed.

In an exemplary embodiment of the display device, the gate driving part 230 provides the gate line GL with a turn-on voltage to turn on the switching element QS.

Then, the data driving part 240 provides the data line DL with a data signal to charge the liquid crystal capacitor Clc and the storage capacitor Cst that are connected to the switching element QS.

Then, the gate driving part 230 provides the gate line GL with a turn-off voltage to turn off the switching element QS.

The data driving part 240 provides the data line DL with an analog voltage higher than the data signal corresponding to a white gradation after the switching element QS is turned off from a turn-on state, such that a leakage current is generated in the switching element QS.

FIG. 8 is a circuit diagram of pixels shown in FIG. 5, showing charging/discharging characteristics of the pixels.

Referring to FIG. 8, when about 1 s is elapsed after an analog voltage of about 8 V is applied to a first data line DL1 a first switching element QS1 in a turn off state by applying a gate-off voltage of about −5 V to a first gate line GL1, a white leakage current is continuously flowing from a source electrode of the first switching element QS 1 to a drain electrode of the first switching element QS 1. Thus, a voltage of the drain electrode of the first switching element QS1 is compensated, such that a voltage of the drain electrode of the first switching element QS1 is about 7 V.

When about 1 second is elapsed after an analog voltage of about −1 V is applied to a second data line DL2 a second switching element QS2 in a turn-off state by applying a gate-off voltage to the first gate line GL1, a white leakage current is continuously flowing from a drain electrode of the second switching element QS2 to a drain electrode of the second switching element QS2. Thus, a voltage of the drain electrode of the second switching element QS2 is compensated, such that a voltage of the drain electrode of the second switching element QS2 is about zero (0) V.

In an exemplary embodiment, as described above, an analog voltage higher than a voltage corresponding to a white data is applied to a pixel to compensate a luminance decreased due to a remaining DC component generated by a gate electrode which is closed, such that a leakage current of a switching element is generated to increase a luminance.

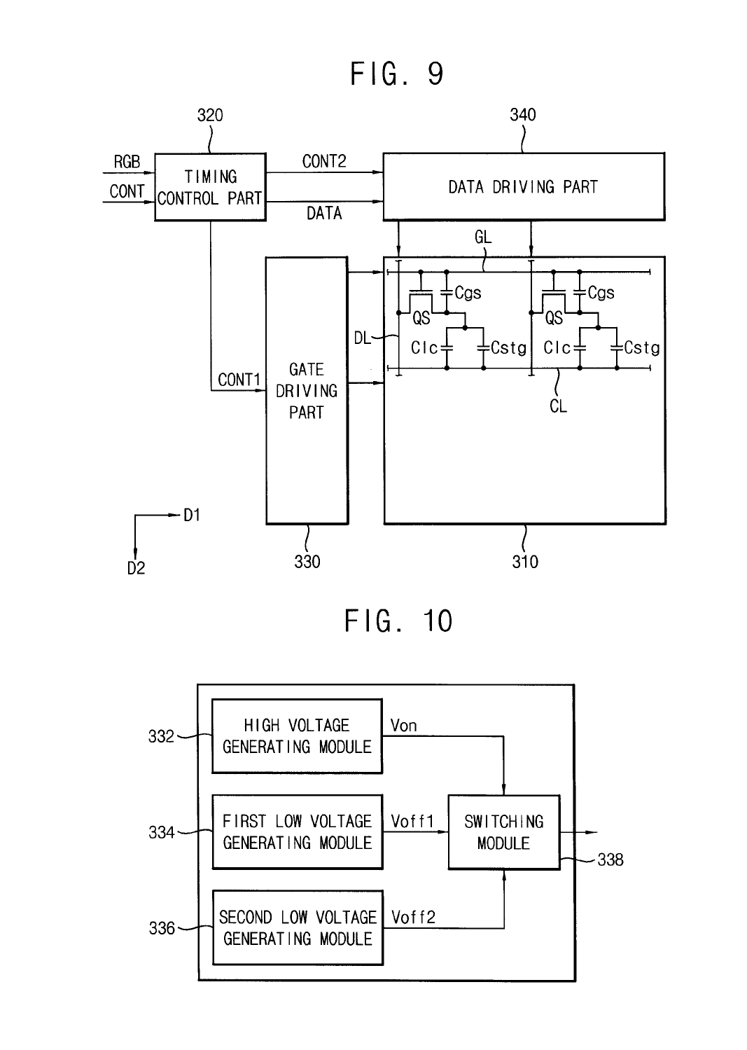

FIG. 9 is a block diagram schematically showing another alternative exemplary embodiment of a display apparatus, according to the invention. FIG. 10 is a block diagram schematically showing an exemplary embodiment of a gate driving part shown in FIG. 9. FIG. 11 is a waveform diagram schematically showing a gate signal outputted from the gate driving part of FIG. 10.

Referring to FIG. 9, FIG. 10 and FIG. 11, an exemplary embodiment of a display apparatus includes a display panel 310, a timing control part 320, a gate driving part 330 and a data driving part 340. In an exemplary embodiment, the gate driving part 330 may function as a leakage current generating part that generates a leakage current in a switching element disposed on the display panel 310 to improve image degradation due to flicker when the display panel 310 is driven at a low frequency.

The display panel 310, the timing control part 320 and the data driving part 340 of the display apparatus shown in FIG. 9 are substantially the same as the display panel 110, the timing control part 120 and the data driving part 140 of the display apparatus shown in FIG. 1, and thus any repetitive detailed description thereof may hereinafter be omitted or simplified.

The gate driving part 330 includes a high voltage generating module 332, a first low voltage generating module 334, a second low voltage generating module 336 and a switching module 338 to generate gate signals for driving gate lines GL in response to the gate driving control signals outputted from the timing control part 320. The gate driving part 330 sequentially outputs the gate signals to the gate lines GL. In one exemplary embodiment, for example, the gate driving part 330 may generate the gate signals outputted to the gate lines GL in accordance with of the first driving control signal CONT1 including a first clock signal, a second clock signal having timing different from the first clock signal and a vertical start signal. In such an embodiment, the second clock signal may be a signal inverted from the first clock signal.

The gate driving part 330 may be directly mounted on the display panel 310 or connected to the display panel 310 in a tape carrier package (“TCP”) manner. Alternatively, the gate driving part 330 may be integrated on the display panel 310.

The high voltage generating module 332 generates a gate-on voltage Von for turning on switching elements QS and provides the switching module 338 with the gate-on voltage Von.

The first low voltage generating part 334 generates a first gate-off voltage Voff1 for turning off the switching elements QS and provides the switching module 338 with the first gate-off voltage Voff1.

The second low voltage generating module 336 generates a second gate-off voltage Voff2 for turning off the switching elements QS, and provides the switching module 338 with the second gate-off voltage Voff2. The second gate-off voltage Voff2 may be higher than the first gate-off voltage Voff1. In one exemplary embodiment, for example, the first gate-off voltage Voff1 is about −5 V, and the second gate-off voltage Voff2 may be about −0.4 V.

The switching module 338 provides the gate line GL, e.g., one of first to n-th gate lines G1 to Gn, with one of the gate-on voltage Von, the first gate-off voltage Voff1 and the second gate-off voltage Voff2. An operation of the switching module 338 may be controlled by the timing control part 320.

In an exemplary embodiment of the display device, the gate driving part 330 provides the gate line GL with a turn-on voltage to turn on the switching element QS.

Then, the data driving part 340 provides the data line DL with a data signal to charge the liquid crystal capacitor Clc and the storage capacitor Cst that are connected to the switching element QS.

Then, the gate driving part 330 selectively provides the switching element QS with a gate-off voltage based on a ratio or a percentage of a high gradation or a low gradation of a full still image displayed on the display panel 310, thereby turning off the switching element QS. In one exemplary embodiment, for example, when the percentage of a white image or a black image of the full still image are equal to or greater than about 20%, e.g., in an n-th frame in FIG. 11, the gate driving part 330 outputs a gate-off voltage of about −5 V. When the percentage of a white image or a black image of the full still image are less than about 20%, e.g., in an (n+1)-th frame in FIG. 11, the gate driving part 330 outputs a gate-off voltage of about −0.4 V.

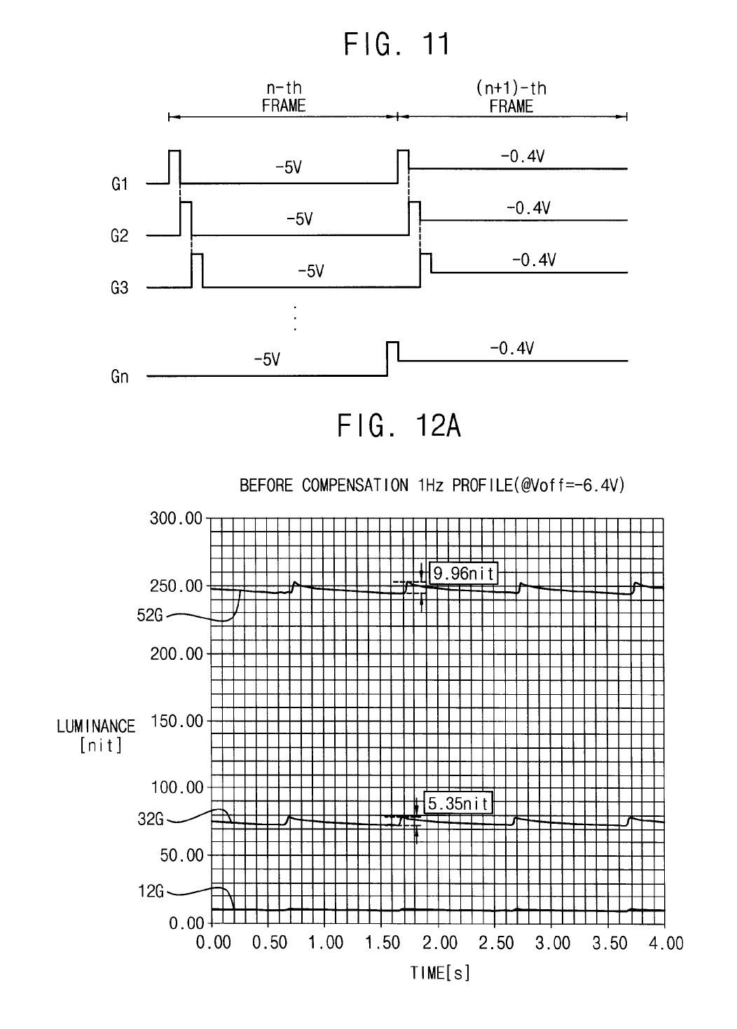

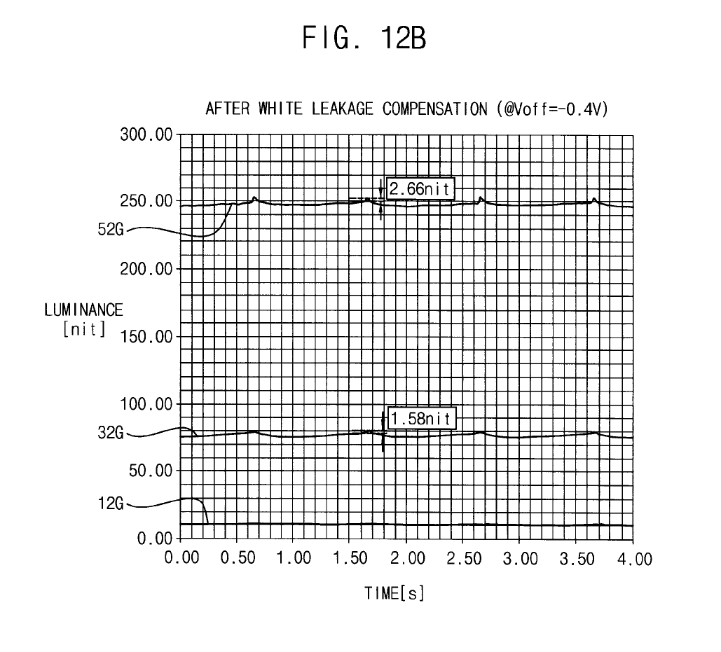

FIG. 12A is a graph explaining a luminance profile in accordance with time before compensation. FIG. 12B is a graph explaining a luminance profile in accordance with time after compensation using the white leakage.

Referring to FIG. 12A, when a gate-off voltage of about −6.4 V is applied to the pixels, a luminance variation corresponding to 32-gradation levels is about 5.35 nits and a luminance variation corresponding to 52-gradation levels is about 9.96 nits.

Referring to FIG. 12B, when a gate-off voltage of about −0.4 V is applied to the pixels, a luminance variation corresponding to 32-gradation levels is about 1.58 nits and a luminance variation corresponding to 52-gradation levels is about 2.66 nits.

Thus, a momentary luminance variation amount is rapidly decreased in a low frequency driving, such that a flicker is substantially reduced.

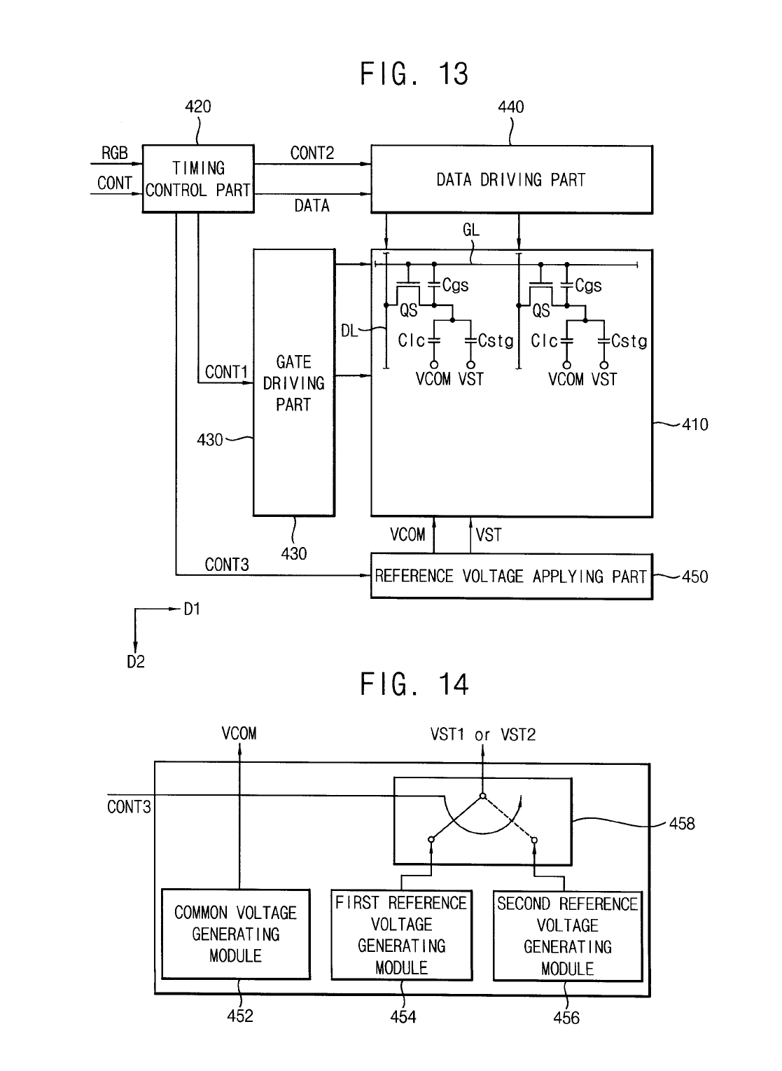

FIG. 13 is a block diagram schematically showing another alternative exemplary embodiment of a display apparatus, according to the invention. FIG. 14 is a block diagram schematically showing an exemplary embodiment of a reference voltage applying part of FIG. 13. Particularly, FIG. 14 shows a reference voltage applying part that applies a common reference voltage VCOM and a storage reference voltage VST to a display panel 410.

Referring to FIG. 13 and FIG. 14, an exemplary embodiment of a display apparatus includes a display panel 410, a timing control part 420, a gate driving part 430, a data driving part 440 and a reference voltage applying part 450. In an exemplary embodiment, the reference voltage applying part 450 may functions as a leakage current generating part that generates a leakage current in a switching element disposed on the display panel 410 to improve an image degradation due to flicker when the display panel 410 is driven at a low frequency.

The display panel 410 includes a plurality of gate lines GL, a plurality of data lines DL and a plurality of unit pixels electrically connected to the gate lines GL and the data lines DL. The gate lines GL extend substantially in a first direction D1, and the data lines DL extend substantially in a second direction D2. The first direction D1 may cross the second direction D2.

Each of the unit pixels may include a switching element QS, a liquid crystal capacitor Clc electrically connected to the switching element QS and a storage capacitor Cstg electrically connected to the switching element QS. A first terminal of the liquid crystal capacitor Clc is connected to a drain electrode of the switching element QS, and a first terminal of the storage capacitor Cstg is connected to the drain electrode of the switching element QS. A common electrode voltage VCOM is applied to a second terminal of the liquid crystal capacitor Clc, and a storage voltage VST is applied to a second terminal of the storage capacitor Cstg. The unit pixels may be disposed substantially in a matrix form. In such an embodiment, a parasitic capacitor Cgs may be formed between the gate and drain electrodes of the switching element QS.

The timing control part 420 receives an input image data RGB and an input control signal CONT from an external device (not shown). The input image data may include a red image data, a green image data and a blue image data. The input control signal CONT may further include a clock signal, a data enable signal, a vertical start signal and a horizontal start signal, for example.

The timing control part 420 generates a first driving control signal CONT1, a second control signal CONT2, a third control signal CONT3 and a data signal DATA in response to the input image data RGB and the input control signal CONT.

The timing control part 420 generates the first driving control signal CONT1 for controlling an operation of the gate driving part 430 in response to the input control signal CONT, and outputs the first driving control signal CONT1 to the gate driving part 440. The first driving control signal CONT1 may include a vertical start signal and a gate clock signal.

The timing control part 420 generates the second control signal CONT2 for controlling an operation of the data driving part 140 in response to the input control signal CONT, and outputs the second control signal CONT2 to the data driving part 440. The second control signal CONT2 may include a horizontal start signal and a load signal.

The timing control part 420 generates the third control signal CONT3 for controlling an operation of the reference voltage applying part 450 in response to the input control signal CONT, and outputs the third control signal CONT3 to the reference voltage applying part 450.

The gate driving part 430 generates gate signals for driving gate lines GL in response to the gate driving control signal CONT 1 inputted from the timing control part 420. The gate driving part 430 sequentially outputs the gate signals to the gate lines GL. In one exemplary embodiment, for example, the gate driving part 430 may generate the gate signals of the gate lines GL in response to the gate driving control signal CONT1 including a first clock signal, a second clock signal having different phase from the first clock signal CK and a vertical start signal. In such an embodiment, the second clock signal may be a signal inverted from the first clock signal.

In an exemplary embodiment, the gate driving part 430 may be directly mounted on the display panel 410 or connected to the display panel 410 in a tape carrier package (“TCP”) manner. Alternatively, the gate driving part 430 may be integrated on the display panel 410.

The data driving part 440 provides the data line DL with a data signal. In one exemplary embodiment, for example, after the switching element QS is turned off from a turn-on state of the switching element QS, the data driving part 440 provides the data line with a data signal corresponding to a white gradation.

The data driving part 440 receives the second control signal CONT2 and the data signal DATA from the timing control part 420. The data driving part 440 converts the data signal DATA into a data voltage of analog type using a gamma reference voltage outputted from a gamma reference voltage generating part (not shown). The data driving part 140 outputs the data voltage to the data lines DL.

The data driving part 440 may include a shift register (not shown), a latch (not shown), a signal processing part (not shown) and a buffer part (not shown). The shift register outputs a latch pulse to the latch. The latch temporarily stores the data signal DATA and then output the data signal DATA to the signal processing part. The signal processing part generates the data voltage of an analog type based on the data signal DATA and the gamma reference voltage to output the data voltage to the buffer part. The buffer part compensates the data voltage to have a predetermined level, and then outputs the data voltage to the data lines DL.

In an exemplary embodiment, as shown in FIG. 14, the reference voltage applying part 450 includes a common voltage generating module 452, a first reference voltage generating module 454, a second reference voltage generating module 456 and a switching module 458. After the switching element QS is turned off from a turn-on state, the reference voltage applying part 450 outputs a voltage higher than a storage voltage applied to the storage capacitor Cstg to a second terminal of the storage capacitor Cstg.

The common voltage generating module 454 generates a common electrode voltage VCOM to provide a second terminal of a liquid crystal capacitor with the common electrode voltage VCOM.

The first reference voltage generating module 454 generates a first reference voltage VST1 to provide the switching module 458 with the first reference voltage VST1. In such an embodiment, the first reference voltage VST1 may be a voltage conventionally applied to a second terminal of the storage capacitor Cstg.

The second reference voltage generating module 456 generates a second reference voltage VST2 to provide the switching module 458 with the second reference voltage VST2. The second reference voltage VST2 is a voltage greater than the first reference voltage VST1. In one exemplary embodiment, for example, the first reference voltage VST1 is about zero (0) V, the second reference voltage VST2 may be about 1 V.

The switching module 458 provides a second terminal of the storage capacitor Cstg with the first reference voltage VST 1 or the second reference voltage VST2 in response to the third control signal CONT3 provided from the timing control part 420.

In an exemplary embodiment of the display device, the gate driving part 430 provides the gate line GL with a turn on voltage to turn on the switching element QS.

Then, the data driving part 440 provides the data lines DL with a data signal to charge the liquid crystal capacitor Clc and the storage capacitor Cst that are connected to the switching element QS.

Then, the gate driving part 430 provides a turn-off voltage with the gate line GL to turn off the switching element QS.

Then, after the switching element QS is turned off from a turn-on state, the reference voltage applying part 450 outputs a voltage, for example, a second reference voltage VST2, higher than a storage voltage, for example, a first reference voltage VST1, applied to the storage capacitor Cstg to the second terminal of the storage capacitor Cstg.

As described above, according to exemplary embodiments of the invention, a leakage current is generated in a switching element to improve image degradation such as a flicker when a display panel is driven at a low frequency, such that a luminance profile that a luminance is decreased until refreshing of the switching element is effectively compensated. Thus, in such embodiments, a flicker due to a low frequency driving may be decreased, a displayable gradation range at a low frequency may be increased, and power consumption may be reduced.

Having described exemplary embodiments of the invention, it is further noted that it is readily apparent to those of reasonable skill in the art that various modifications may be made without departing from the spirit and scope of the invention which is defined by the metes and bounds of the appended claims.

What is claimed is:

1. A display apparatus comprising:
a display panel comprising a gate line, a data line, a switching element connected to the gate line and the data line, a liquid crystal capacitor having a first terminal connected to the switching element, and a storage capacitor having a first terminal connected to the switching element; and
a leakage current generating part which generates a leakage current in the switching element.

2. The display apparatus of claim 1, wherein
the leakage current generating part comprises a data driving part which provides the data line with a data signal, and
the data driving part outputs a high data signal higher than the data signal corresponding to a white gradation of positive polarity after the switching element is turned off from a turn-on state.

3. The display apparatus of claim 2, wherein
the data driving part outputs a low data signal lower than the data signal corresponding to a white gradation of negative polarity after the switching element is turned off from the turn-on state.

4. The display apparatus of claim 1, wherein
the leakage current generating part comprises a data driving part which provides the data line with a data signal, and
the data driving part outputs an analog voltage higher than the data signal corresponding to a white gradation of positive polarity after a frame scanning is completed.

5. The display apparatus of claim 4, wherein
the data driving part outputs an analog voltage lower than the data signal corresponding to a white gradation of negative polarity after the frame scanning is completed.

6. The display apparatus of claim 1, wherein
the leakage current generating part comprises a gate driving part which provides the gate line with a gate signal, and
wherein the gate driving part selectively outputs a gate-off voltage to the gate line based on a percentage of a high gradation or a low gradation of a full still image.

7. The display apparatus of claim 6, wherein
the gate driving part outputs the gate-off voltage of about −5 volts when a percentage of a white image or a black image of the full still image is equal to or greater than a predetermined percentage, and
the gate driving part outputs the gate-off voltage of about −0.4 volt when the percentage of the white image or the black image of the full still image is less than the predetermined percentage.

8. The display apparatus of claim 1, wherein
the leakage current generating part comprises a reference voltage applying part which provides a second terminal of the storage capacitor with a storage voltage, and
wherein the reference voltage applying part outputs a voltage higher than a storage voltage applied to the storage capacitor after the switching element is turned off from the turn-on state.

9. The display apparatus of claim 1, wherein the display panel is driven at a low frequency lower than about 60 hertz.

10. A method of driving a display apparatus comprising a gate line, a data line, a switching element connected to the gate line and the data line, a liquid crystal capacitor having a first terminal connected to the switching element, and a storage capacitor having a first terminal connected to the switching element, the method comprising:
providing the gate line with a turn-on voltage to turn on the switching element;
providing the data line with a data signal to charge the liquid crystal capacitor and the storage capacitor;
providing the gate line with a turn-off voltage to turn off the switching element; and
providing the data line with a high data signal higher than the data signal corresponding to a white gradation of a positive polarity to generate a leakage current in the switching element after the switching element is turned off from a turn-on state.

11. The method of claim 10, further comprising:
providing the data line with a low data signal lower than the data signal corresponding to a white gradation of a negative polarity to generate the leakage current in the switching element after the switching element is turned off from the turn-on state.

12. A method of driving a display apparatus comprising a gate line, a data line, a switching element connected to the gate line and the data line, a liquid crystal capacitor having a first terminal connected to the switching element, and a storage capacitor having a first terminal connected to the switching element, the method comprising:
providing the gate line with a turn-on voltage to turn on the switching element;
providing the data line with a data signal to charge the liquid crystal capacitor and the storage capacitor;
providing the gate line with a turn-off voltage to turn off the switching element; and
providing the data line with an analog voltage higher than the data signal corresponding to a white gradation of positive polarity to generate a leakage current in the switching element after a frame scan is completed.

13. The method apparatus of claim 12, further comprising:
providing the data line with an analog voltage lower than the data signal corresponding to a white gradation of negative polarity to generate the leakage current in the switching element after the frame scan is completed.

14. A method of driving a display apparatus comprising a gate line, a data line, a switching element connected to the gate line and the data line, a liquid crystal capacitor having a first terminal connected to the switching element and a storage capacitor having a first terminal connected to the switching element, the method comprising:
providing the gate line with a turn-on voltage to turn on the switching element;
providing the data line with a data signal to charge the liquid crystal capacitor and the storage capacitor; and
selectively providing the gate line with a gate-off voltage based on a percentage of a high gradation or a low gradation of a full still image displayed on the display apparatus to generate a leakage current.

15. The method of claim 14, wherein
the gate-off voltage of about −5 volts is provided to the gate line when a percentage of a white image or a black image of the full still image is equal to or greater than a predetermined percentage, and
the gate-off voltage of about −0.4 volt is provided to the gate line when the percentage of the white image or the black image of the full still image is less than the predetermined percentage.

16. A method of driving a display apparatus comprising a gate line, a data line, a switching element connected to the gate line and the data line, a liquid crystal capacitor having a first terminal connected to the switching element and a storage capacitor having a first terminal connected to the switching element, the method comprising:
providing the gate line with a turn-on voltage to turn on the switching element;
providing the data line with a data signal to charge the liquid crystal capacitor and the storage capacitor;
providing the gate line with a turn-off voltage to turn off the switching element; and
providing a second terminal of the storage capacitor with a voltage higher than a storage voltage applied to the storage capacitor to generate a leakage current in the switching element, after the switching element is turned off from a turn-on state.
